(19) United States
(12) Patent Application Publication
(10) Pub. No.: US 2010/0268651 A1
(43) Pub. Date: Oct. 21, 2010

(54) AUTOMATIC GENERATION OF A SCENARIO USED TO OPTIMIZE A BID AWARD SCHEDULE

(76) Inventors: Olga Raskina, Arlington, MA (US); Sean Correll, Dover, MA (US); Jeffrey Robbins, Lexington, MA (US)

Correspondence Address: ROBERT SCHULER, 45 GROTON ROAD, SHIRLEY, MA, 01464, US

(21) Appl. No.: 12/426,639

(22) Filed: Apr. 20, 2009

(51) Int. Cl. G06Q 30/00; G06Q 10/00

(52) U.S. Cl. 705/80; 705/7

(57) ABSTRACT

An sourcing event management system includes a presentation layer, a business logic layer, an infrastructure layer and storage and operates to facilitate the creation of a bidding scenario, the opening of a bidding process, reception of bids from suppliers, the closing of the bidding process and the analysis of the bids received from the suppliers to determine an optimal bid award schedule. The sourcing event management system also includes a modified mathematical model that is solved, subject to constraints selected by a buyer and to variables specified by the buyer, to determine how the constraints can be modified to further optimize the bid award schedule.

### FIELD OF THE INVENTION

This invention relates generally to the area of electronic bidding and specifically to automatically analyzing the results of a bidding event for an optimal award schedule.

### BACKGROUND

To achieve and maintain prosperity, a business is frequently called upon to make decisions concerning where to acquire various goods and services. In the context of manufacturing, raw materials that are to be processed or assembled to manufacture a product must be replaced if additional products are to be manufactured. Similarly, a service business often consumes supplies in the process of delivering services to its customers. These supplies must likewise be replaced if the services are to continue. Supplies can be tangible goods, for example iron and coke used to make steel, or they can be intangible services, for example collection services for collecting delinquent payments

In a conventional method for acquiring items, a buyer opens a bidding event, which is typically referred to as an auction, a request for quotation (RFQ), a request of proposal (RFP), etc., to prospective suppliers. The RFQ contains a list of items the buyer would like to purchase. In some cases, the RFQ contains additional information pertinent to the proposed transaction, such as minimum or maximum quantities, delivery dates or standards of quality. As such, the RFQ can be viewed as a collection of constraints imposed by the buyer on a proposed transaction.

In response to an event, the prospective suppliers submit bids, which are essentially offers to enter into a contract with the buyer. These bids typically include offer prices together with additional proposed terms. The response can thus be viewed as a collection of constraints imposed by the prospective supplier on the proposed transaction.

To the extent that the constraints imposed by the buyer and the constraints imposed by a particular supplier are both met, a transaction between the buyer and the particular supplier is feasible. In a typical event, there will be numerous suppliers for which this is the case. The buyer must then choose which of these suppliers are to be awarded the bid. The optimal combination of suppliers, together with the list of items to be ordered from each supplier, is referred to as an optimal award schedule.

Where price is the buyer's sole concern, and all bids can yield a unit price-per-item, the process of determining an optimal award schedule is decidedly trivial. One simply selects the supplier offering the lowest price-per-item. If the buyer requires additional quantities of that item once that supplier's supply of the item is exhausted, the buyer then selects the supplier having the next lowest price-per-item. This process continues until the buyer's constraint on the quantity of the item has been met.

In reality, however, modem business-to-business transactions are seldom so simple. For example, a supplier's price for an item can be made to depend on the quantity of that item purchased. Or, the supplier may give one price for a bundle of disparate items, in which case it is unclear how to allocate this price among the items. In addition, other less clearly quantifiable factors must often be considered. For example, the quality of goods or the reputation of the supplier for reliability, or the supplier's solvency, may need to be considered. The buyer may also have internally generated policies, or business rules, that further constrain the choice of which suppliers can be awarded which bids. Additionally, the relative importance of the various factors can vary depending on the context in which the decision is made. For example, anyone who has been a passenger on a commercial airline might reasonably infer that it is more important for meals be delivered to the aircraft prior to the scheduled departure time than it is that the meals stimulate the palate. Similarly, in purchasing latex gloves for a fast food restaurant, a slight porosity of the glove may not be as important as a low price. In contrast, when purchasing latex gloves for an operating room, the price savings may be irrelevant given the far more serious consequences of contamination.

The complexity of compiling a quantitatively justifiable schedule of optimal awards given all the foregoing constraints is daunting even when the choice is limited to a few suppliers bidding on a limited number of items. Event management and analysis applications are available that automate the process of creating and managing a bidding process and evaluating the results of an event to generate an optimal award schedule. One such application is marketed by Emptoris, Inc. and is referred to as the Emptoris “Sourcing Solution”. Generally, such applications operate, according to a set of selected constraints, to facilitate setting up an event by creating an RFQ, creating supplier profiles, opening the event, bidding at the event, closing the event, and analyzing the bids received from suppliers to determine an optimal award schedule. Each optimal award schedule that is generated by the application, according to the set of selected constraints, is referred to as a scenario.

Often, it is desirable to create multiple scenarios by manually modifying certain flexible constraints, such as business rules, and re-running the analysis application, in order to determine whether such modifications further optimize the award schedule or not. For example, a first scenario can use a constraint that limits minority suppliers to no more than ten percent of an award. A second scenario can include the same constraint but with an eight percent minority limit. The award schedule resulting from running the application with the first and second scenarios can be compared and an award strategy is selected that provides the most reasonable trade-off between requirements and the total cost of the award. However, given even a small number of flexible constraints, thousands of scenarios can be manually generated and the process of manually generating these thousands of different scenarios for evaluation can become a practical impossibility. Further, it is typically not known if there are any other strategies that are similar to the ones evaluated, but which can yield a lower total cost.

Summary: Therefore, a sourcing event management system into which are entered one or more buyer designated constraint variable values and which system operates to automatically create a plurality of optimal, alternative award scenarios is of considerable value.

According to the invention, a sourcing event management system operates to implement a method that automatically generates an optimal bid award scenario, wherein the method is comprised of the system calculating an initial value for a bid award scenario; defining a mathematical model which is employed by the system to minimize a bid award schedule; a buyer defining flexibility of one or more constraint that the mathematical model is subject to; the system calculating a constraint variable value for each of the buyer flexible constraints; and the system minimizing the mathematical model subject to each of the calculated constraint variable values to identify modifications to the one or more constraints that will further optimize the initially calculated bid award value.

### BRIEF DESCRIPTION OF THE DRAWINGS

FIG. 1 is a diagram of a network that can accommodate a sourcing event management system.

FIG. 2 is a block diagram showing one buyer and a plurality of suppliers connected to a sourcing event management system.

FIG. 3A is a schematic representation of a mathematical model included in the sourcing event management system of FIG. 2.

FIG. 3B is a schematic representation of a modified mathematical model included in the sourcing event management system of FIG. 2.

FIG. 4A is a portion of a logical flow diagram of an embodiment of the invention.

FIG. 4B is a continuation of the logical flow diagram of FIG. 4A.

FIG. 4C is a continuation of the logical flow diagram of FIG. 4B.

Detailed Description: Attached hereto is as Appendix II is U.S. patent application identified by Pub. No. 2003/0004850A1 entitled “Auction Management”, the entire contents of which are incorporated by reference.

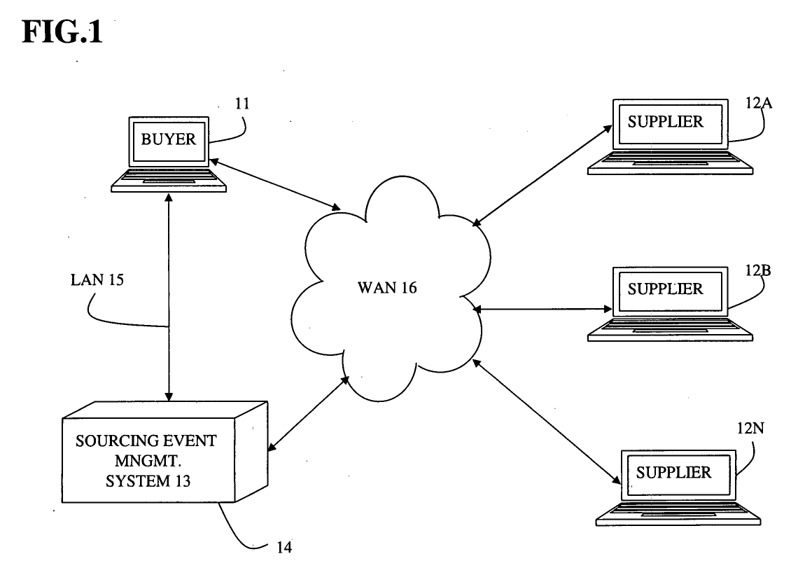

A network suitable for running a bidding or sourcing event, such as the network 10 shown in FIG. 1, is generally employed by one or more buyers to set up and start a bidding process, to manage the bidding of a plurality of suppliers and to analyze the results of the bidding process to determine an optimal award schedule for the one or more buyers. Such a network 10 can include a sourcing event management system 13 which can be an application stored in memory of any type of suitable computational device, such as server 14 that can be connected to both a wide area network 16 and to a local area network 15. The sourcing event management system 13 is accessible by the buyers over either a local area network 15 (LAN) employing the well known Ethernet technology or is accessible by the buyers over a wide area network 16 (WAN) such as the Internet. The sourcing event management system 13 is typically accessible by the suppliers over a WAN such as the WAN 16, but any wide area public or private network can meet the communication needs of the event management process.

The sourcing event management system 13 of FIG. 1 generally includes functionality that permits buyers registered to use the system 13 to create a bidding or sourcing event, comprised of, among other things, a request for quotation (RFQ) or request for proposal (RFP) for example, which can include a requisitions list of items or groups of items that the buyer wants to purchase. Such a listing can include a description of the items, a desired quantity of each item and any other information that the supplier might need to make an informed bid on the items in the requisitions list. By imposing contract terms that are required by the buyer in any prospective contract with the supplier, this requisitions list defines a set of published buyer constraints. Throughout this specification, the term “item” is sometimes used to refer to both goods and services.

The sourcing event management system 13 of FIG. 1 also includes functionality that accepts bids from suppliers registered to use the system, or non-registered suppliers, in response to a buyer's RFQ. Each supplier can enter their bid into the system 13 which stores the information contained in the bid for later analysis. At a time that can be specified by the buyer, the event is closed to bidding and the sourcing event management system 13 proceeds to analyze the bids received from each of the suppliers to determine the optimal award schedule. Alternatively, the sourcing event management system 13 can analyze bids received by another system, whether that system is a sourcing event management system or not. Also, this analysis can occur before the sourcing event is closed. During the analysis portion of the event management process, the buyer has the opportunity to impose additional, constraints on the optimization process. For instance, a particular supplier can be constrained to providing a limited number of each item in the requisitions list or may be constrained to providing a limited number of a particular item included in the requisitions list. The buyer can run the sourcing event management system 13 bid analysis processes, manually modify one or more constraints and then run the analysis process again in an attempt to further optimize the award schedule. Each time the buyer manually modifies the constraints for analysis by the sourcing event management system 13, they are creating a different or alternative sourcing event scenario. Depending upon the number of constraints the buyer modifies and depending upon the complexity of the requisitions list, the number of different alternative sourcing event scenarios that the buyer creates can be in the hundreds or thousands. In this case, the process of manually modifying constraints to create different scenarios and re-running the sourcing event management system 13 analysis process to analyze the alternative scenarios can be a very time consuming task.

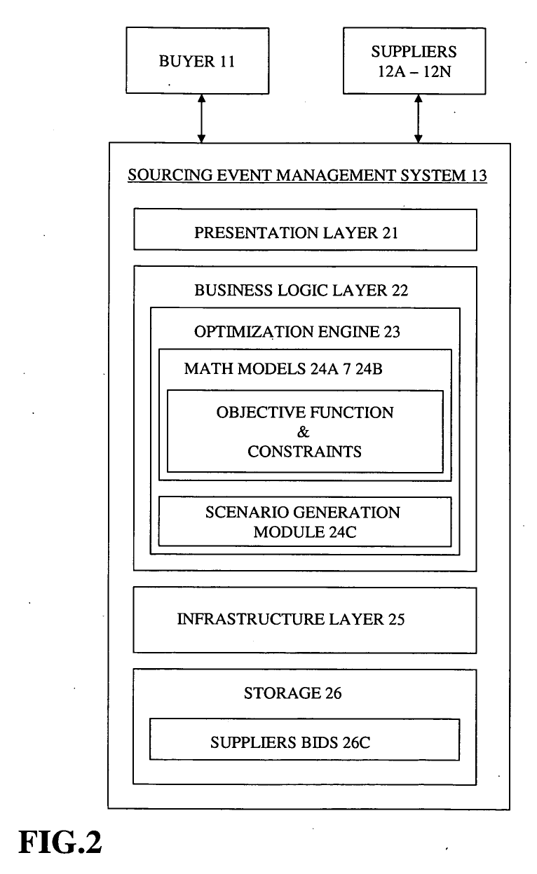

FIG. 2 is a block diagram showing one buyer 11 of a possible plurality of buyers, a plurality of suppliers 12A-12N and the sourcing event management system 13 all described earlier with reference to FIG. 1. The one buyer 11 and plurality of suppliers 12A-12N can all be registered to use the system 13 and in communication with the sourcing event management system 13 over the respective networks as described earlier with reference to FIG. 1. Further, each buyer and supplier can employ a web browser associated with a computational device, not shown, to access functionality included in the sourcing event management system 13. The sourcing event management system 13 is comprised of a presentation layer 21, a business logic layer 22, an infrastructure layer 25 and storage area 26. The presentation layer 21 can include a supplier's workspace and a buyer's workspace that serves as an interface to the sourcing event management system 13 respectively permitting the suppliers and buyers access to the functionality provided by the system 13, such as the business logic layer 22, the infrastructure layer 25 and the storage 26. The business logic layer 22 includes an optimization engine 23 that employs a mathematical model 24A or 24B to operate on the results of a bidding process, maintained in storage 26, to optimize an award schedule. In the preferred embodiment of the invention, the mathematical models 24A and 24B are comprised of an objective function and one or more supplier and buyer constraints. The optimization engine 23 also includes, according to one embodiment of the invention, a scenario generation module 24C which is used by the buyer 11 to specify alterations to selected published or unpublished buyer constraints. The alterations to the constraints are effected in a manner that permits the optimization engine 23 to automatically analyze all or substantially all the possible scenarios resulting from the alteration to the constraints. As the result of this analysis, the sourcing event management system 13 is able to recommend how one or more of the constraints can be modified to further optimize the award schedule. The infrastructure layer 25 can include services that authorize the buyers and suppliers to access the system 13, that implement communications between the system 13 and the buyers and suppliers and that implement transaction and session management. And finally, the storage 26 can be any device or system that is able to store large amounts of information which in this case can be supplier bid information 26C accepted during a bidding event.

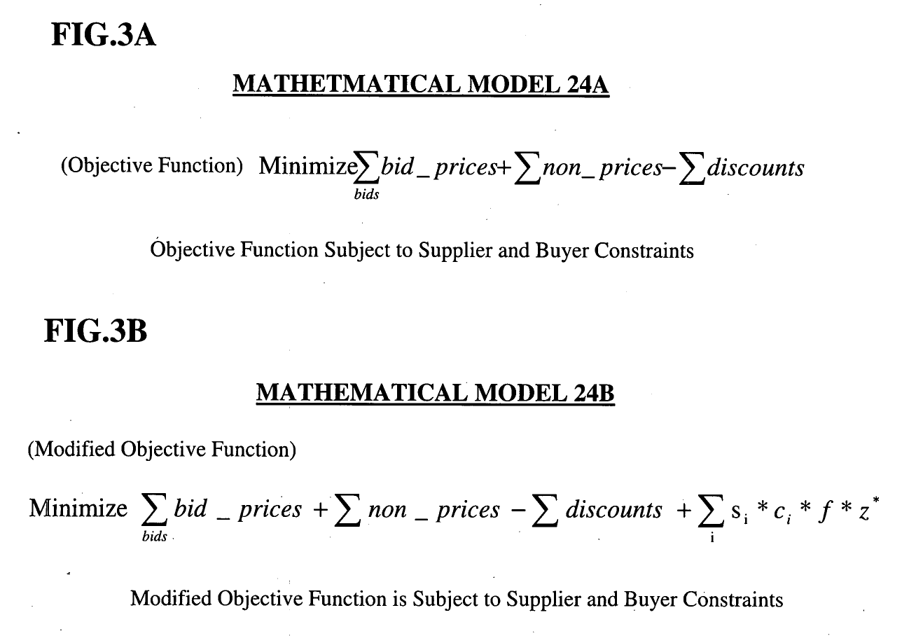

FIG. 3A is schematical representation of the mathematical model 24A of FIG. 2. The mathematical model 24A in the preferred embodiment is comprised of a linear objective function subject to linear equality and linear inequality constraints, such as buyer constraints referred to with respect to FIG. 2. The mathematical model 24A, which is evaluated by the optimization engine 23, is comprised of a “bid_price” term, a “non_price” term and a “discounts” term, collectively referred to herein as “bid terms”, which may or may not be included depending upon the RFQ and accepted bids. The bid_price term is the sum of a supplier's conventional bids for an item and the price attributable to that item from any bundled or volume bids that include that item. In addition there could also be additional costs applied by the buyer to a bid or group of bids, these could for example represent some soft cost penalties imposed by the buyer. The non_price term is formed by weighting the supplier's offer price for an item by a quantity that depends on the values of all the performance attributes associated with that item and with that supplier. This is then weighted again by a quantity indicative of how important those performance attributes are by the buyer. Optionally, the discounts term can be included in the mathematical model 24A. This term can be included in the event that a supplier specifies in their bid that they are willing to discount the price on an item or grouping of items. The mathematical model 24A is described in detail in Appendix I hereto, starting on page nine in paragraph [144], and is referred to as an “objective function”. In the preferred embodiment of the invention, the mathematical model 24A is implemented as an objective function, but it could just as easily be implemented as a combination of cost-defining constraints a different objective function terms. Continuing to refer to FIG. 3A, subsequent to receiving bids from suppliers, the optimization engine 23 of FIG. 2 employs the bid pricing and non-pricing information accepted during the bidding event and any optional discount term (all together which comprise a first scenario) to evaluate the mathematical model 24A. The result of this evaluation is an initial bid award value “z*” of the mathematical model 24 and this value “z*” is defined here as the initial value or initial bid award value of the mathematical model 24A as evaluated by the optimization engine 23 prior to any alternative scenarios being created and analyzed. As described previously with reference to FIG. 2, it is advantageous for a buyer to be able to create and analyze some number of alternative award scenarios to determine whether or not these alternative scenarios further optimize an award schedule. Unfortunately, manually altering the unpublished buyer constraints needed to create a large number of different scenarios can be an arduous and time consuming process. A method for automatically evaluating a large number of different alternative scenarios to determine which of the scenarios can further optimize an award schedule is described here. To this end, a special mathematical model variable or special constraint variable “sᵢ” is introduced that permits the optimization engine 23 to determine which modifications to buyer selected constraint limits will result in a significantly lower value for the initial mathematical model 24A value “z*”. The suggested constraint limit modification or modifications are entered into the sourcing event management system 13 which then analyses the objective function, subject to the modifications made to the unpublished buyer constraints, to arrive at an optimal award schedule. The system 13 can determine that more than one scenario can further optimize an award schedule, and as such it should be understood that the system 13 can suggest that more than one set of modifications be made to the constraints in order to determine the optimal modifications to the award schedule.

Continuing to refer to FIG. 3A, the mathematical model 24A is initially evaluated by the optimization engine 23 subject to a set of buyer and supplier constraints to obtain an initial bid award value “z*”. These constraints can be grouped into at least five categories; namely, a first constraint category in which all buyer defined item quantities are met, a second constraint category in which all supplier limitations are met, a third constraint category in which all buyer absolute limitations are met, a forth constraint category in which all buyer relative limitations are met and a fifth constraint category can include any other constraints and decision variables (whether or not a bid is bundled or conventional, for instance) that the optimization engine 23 can employ to support the constraints of the first four types. It should be understood that embodiments of the invention are not only limited to the constraints described herein and in Appendix I attached hereto starting in paragraph [0144]. Further, it should be understood that the schematic representations of the constraint categories listed below in Table 1 are for the purposes of illustration only and that the inequality notations “≦” or “≧” can be applied interchangeably to any of the constraint categories. Each of the first, second, third, forth and fifth categories are listed in schematic form in the following Table 1.

TABLE 1

| | |
|---|---|
| 1^{st} Category: | item_min_qty ≦ Σbids ≦ item_max_qty |
| | (for all items) |
| 2^{nd} Category: | Σ values ≦ or ≧ supplier_limit (for all items) |
| 3^{rd} Category: | Σ values ≦ or ≧ buyer_abs.limit (for all abs.limits) |
| 4^{th} Category: | Σ values ≦ or ≧ buyer_relative_limit · |
| | Σ other values (for all relative limits) |
| 5^{th} Category: | Other constraints not described above. |

The first and second constraint categories listed above in Table 1 can be employed by a buyer as published constraints and are typically not modified by a buyer to create multiple different alternative scenarios. Whereas, the third and forth constraints listed in Table 1 can be employed by a buyer as unpublished constraints (supplier may never see these constraints). These unpublished constraints can be specified by a buyer to be flexible and therefore can be modified in various ways to create multiple different alternative scenarios. Alternatively, the third and forth constraints can be exposed to the suppliers. For example, if the absolute limit imposed upon a particular supplier is 1000 units of a particular item, and a buyer specifies that the limit of this constraint can be altered by up to ten percent, then the range over which this constraint can be varied is the range from 1000 units to 1100 units. Also, with respect to the forth constraint category, if the relative limit imposed upon a group of suppliers is 10%, that is, this group of suppliers can provide no more than 10% of the units against some larger number of units in a requisition, and the buyer determines that they are willing to alter this limit by up to fifteen percent, then the range over which this constraint can be varied is the range from 10% to 11.5% of units. I should be understood, that embodiments of the invention are not limited only to the two unpublished constraint categories listed in Table I above.

The range over which a buyer specifies alteration of either an absolute or relative limit in a constraint is referred to herein as the buyer's constraint flexibility “pᵢ” for constraint “i” of either the third or forth categories of constraints listed in Table 1 above. The buyer's constraint flexibility “pᵢ” can be specified to be either an absolute value or a relative value (i.e., 15 units of 500 units or 10% of 500 units). Further, the terms “laᵢ” and “lrᵢ” are defined to be the absolute and relative limits of constraint “i” of the third and forth constraint categories respectively. And finally, a significance value “f” is defined by either a buyer or the sourcing event management system 13 to be a value that is considered to be a “significant” change in the value of the mathematical model 24A as it is evaluated from one scenario to another scenario. This significance value is subjective and can vary from buyer to buyer depending upon the dollar or unit volume of the results of a bidding event, but can be for example 5% of the total cost z*. Regardless, the significance value “f” can be defined to be a fraction of the initially evaluated value “z*” of the mathematical model 24A (i.e., the value of “f” can be equivalent to 10% of the value of z*) or it can be defined to be an absolute value (i.e., the value of “f” can be equivalent to 10 units of the total unit value of z*). In the preferred embodiment, the significance value “f” is a fractional value of the mathematical model 24 value “z*”. So for instance, if the initial value of the mathematical model 24A is 100 and the significance value is defined to be one-one hundredth ( 1/100), then a change in the value of the mathematical model 24A from one scenario to another that is at least equal to “1” is considered to be a significant change in the value. The set of a buyer specified flexibility value, significance value, and absolute and relative limits to a particular unpublished constraint constitutes the definition of that particular constraint and this constraint definition is maintained in the store 26 as one of a plurality of unpublished constraints 26B. The definition of an unpublished buyer constraint can also be comprised of other, supplier specific information, such as a supplier ID for instance. The definition of any of the plurality of these unpublished constraints 26B can be altered through use of the scenario generation module 21A included in the presentation layer 21 of the sourcing event management system 13. Further, and for the purposes of this description, the significance value “f”, the buyers constraint flexibility “pᵢ”, and the terms “laᵢ” and “lrᵢ” are all defines herein to be buyer specified constraint variables.

As described above with reference to FIG. 3A, in order to automatically evaluate the mathematical model 24A against a plurality of alternative scenarios, the special constraint variable “sᵢ” was introduced. This special constraint variable “sᵢ” can be applied to either published or un-published constraints, but in the preferred embodiment is applied only to un-published buyer constraints. Further, it should be understood that although the calculation for a value of the special constraint variable “sᵢ” is described below with reference to four equations 1, 2, 3 and 4, it is possible to calculate this value differently. The buyers constraint flexibility value “pᵢ” for constraint “i” and the absolute limit “laᵢ” the buyer places on constraint “i” are employed by the sourcing event management system 13 to calculate a value for the unpublished special constraint variable “sᵢ”, referred to hereafter as simply constraint variable “sᵢ” with respect to the third constraint category as shown in Equation 1 below. Equations 1, 2, 3 and 4 below are all formulated to use a fractional value of “pᵢ”, however, these Equations can be easily reformulated to employ an absolute value of “pᵢ”.

sᵢ≦pᵢ·laᵢ Equation 1:

The resulting value of the unpublished constraint variable “sᵢ” is used as a term in Equation 2, shown below, to define the range over which the corresponding unpublished buyer constraint is to be evaluated. Equation 2 is a schematic representation of a modified, unpublished constraint “i”. For example, if the value of the absolute limit of constraint “i ” is set by a buyer to be “100” and the buyers constraint flexibility value is set to be “0.1”, then the range of values for the unpublished constraint variable “sᵢ” is the range of values between one and ten (1-10). In this case, assuming that the sourcing event management system 13 generates an alternative scenario for each integer value in the range (1-10), then ten different, alternative scenarios can be generated based on the modification of this one unpublished constraint. It can be easily seen that, as a buyer selects two or more unpublished constraints for modification, the number of possible combinations of different alternative scenarios that can generated becomes very large.

Σ values−sᵢ≦laᵢ Equation 2:

Further, the buyers constraint flexibility value for constraint “i”, the relative limit the buyer places on constraint “i” and the sum of the awards to any other suppliers “Σ other values” are employed by the sourcing event management system 13 to calculate a value for an unpublished constraint variable “sᵢ” with respect to the forth constraint category as shown in Equation 3 below

sᵢ≦pᵢ·lrᵢ·Σ other values Equation 3:

The resulting value of the unpublished constraint variable “sᵢ” is used as a term in Equation 4, shown below, to define the range over which the corresponding unpublished buyer constraint is to be evaluated. Equation 4 is a schematic representation of a modified unpublished constraint “i”.

Σ values−sᵢ≦lrᵢ·Σ other values Equation 4:

Subsequent to a buyer selecting one or more unpublished constraints “i” for alteration and then specifying a constraint flexibility value “pᵢ” and the absolute limit “laᵢ” or relative limit lrᵢ (if the limits are not already specified) of constraint “i”, the sourcing event management system 13, or more specifically the optimization engine 23, can evaluate a modified mathematical model 24B described below with reference to FIG. 3B. The result of minimizing the modified mathematical model 24B is an indication by the sourcing event management system 13 of the modification to the constraint(s) “i” that can be made by the buyer to further optimize an award schedule. So for instance, following the example above with reference to Equation 2, if the result of minimizing the modified mathematical model 24B is “4”, then the sourcing event management system 13 can recommend that the buyer change the limit of constraint “i” to be “104”.

FIG. 3B is a schematical representation of the modified mathematical model 24B. The modified mathematical model 24B is the same as the mathematical model 24A with the exception of an additional three or optionally four terms. The modified mathematical model 24B is comprised of a “bid_price” term, a “non_price” term a “discounts” term, which may or may not be included depending upon the RFQ and accepted bids, and is subject to one or more supplier and/or buyer constraints. The bid_price term is the sum of a supplier's conventional bids for an item and the price attributable to that item from any bundled bids that include that item. The non_price term is formed by weighting the supplier's bid price for an item by a quantity that depends on the values of all the performance attributes associated with that item and with that supplier. This is then weighted again by a quantity indicative of how important those performance attributes are to the buyer. Optionally, additional terms, such as discounts terms can be included in the mathematical model 24A. This term can be included in the event that a supplier specifies in their bid that they are willing to discount the price on an item or grouping of items. In addition to the forgoing terms, the modified mathematical model 24B can additionally be comprised of the summation, over all modified unpublished constraints “i”, of the product of three terms. The first term is the constraint variable “sᵢ”, the second term is the significance value “f” and the third term is an initial value “z*” of the mathematical model 24A. The second and third terms together represent a fractional portion of the total initial value of the mathematical model 24A.

In addition to the three terms described above, an optional fourth term “cᵢ”, which is referred to here as the scaling factor, can be included in the modified mathematical model 24B as shown in FIG. 3B. A separate scaling factor is calculated for each of the unpublished constraint variables “sᵢ” and each scaling factor is calculated according to the “scale” of each of the constraints “i” of the category three and category four constraints described earlier with reference to Table 1. Generally, the calculation of each scaling factor results in an estimate of how much each of the constraints “i” affect the award schedule. In this regard, the scaling factor defines how many of the bids that are received by the sourcing event management system 13 during the course of a bidding event are affected by each of the constraints “i”. For example, if a constraint of category 4 specifies that a particular supplier is to provide twenty percent of a particular item in the requisitions list that includes two or more items, then this constraint only has an effect on one item and so should be assigned less weight than a constraint that has an effect on two or more of the items in the requisition list. The scaling factor “cᵢ” is calculated as follows. Let “N” be the total number of bids in a single event. Then, for each constraint “i”, let “nᵢ” be the number of bids that constraint “i” spans. For all constraints of the third category, define “vᵢ=pᵢ·laᵢ” and for all constraints of the forth category, define “vᵢ=pᵢ·z*·lrᵢ”. Then “cᵢ=vᵢ·nᵢ/N”. Although the calculation of a value for the scaling factor is described above with respect to particular relationships between terms, it can be calculated in a different manner and is not limited to being calculated as described here.

As mention above with reference to FIG. 3B, after the modified mathematical model 24B is solved and the recommended modifications to any of the constraint limits are known, these modifications are entered into the auction management system 13 which then proceeds to analyze the new scenario to determine the optimal award schedule. The advantage of an sourcing event management system 13 with the capability of automatically determining which one or ones of a large number of alternative scenarios can have a significant effect of the optimization of a award schedule is a power time saving tool.

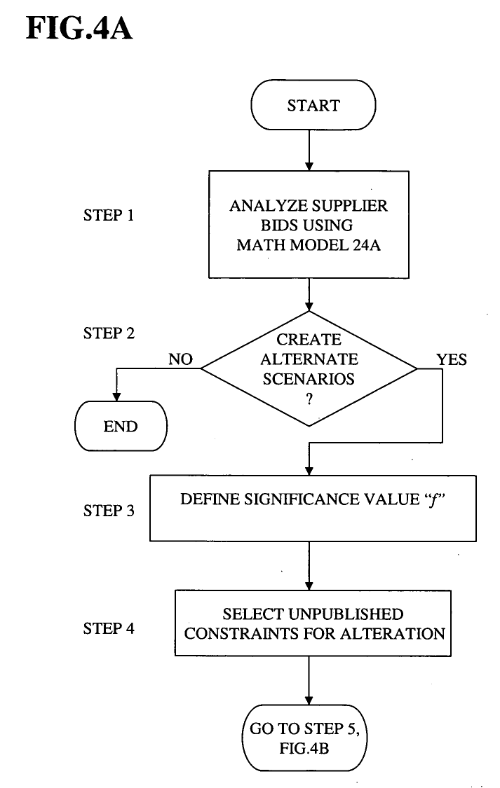

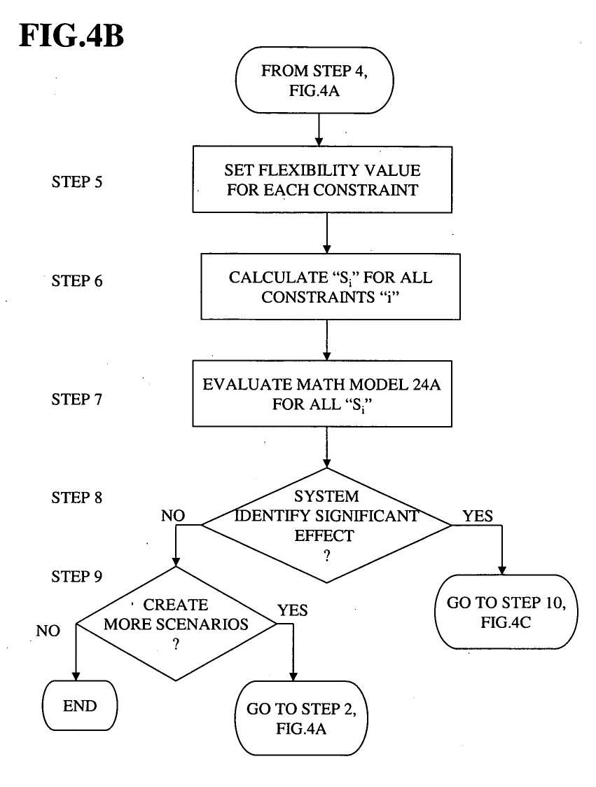

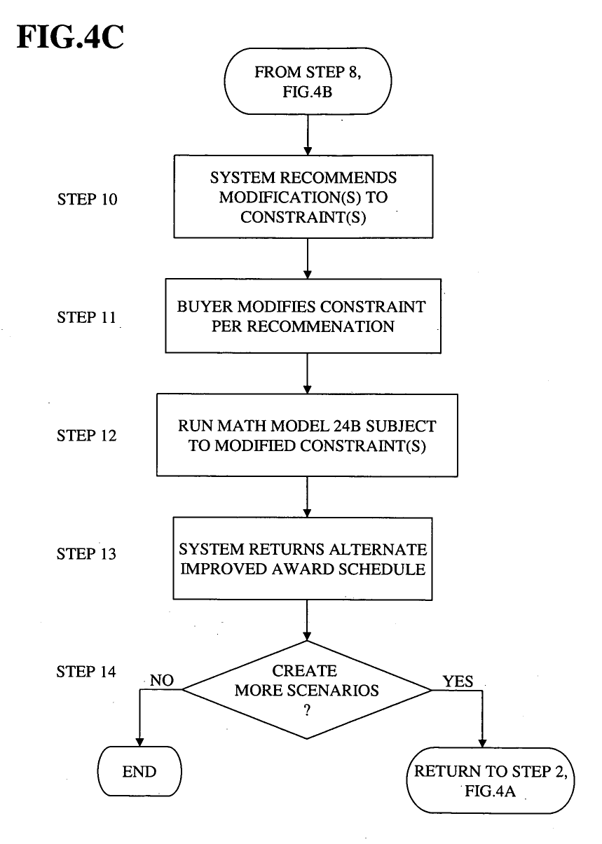

FIGS. 4A, 4B and 4C are a logical flow diagram of the process of the preferred embodiment of the invention. For the purposes of this description, it is assumed that in the context of the sourcing event management system 13, one or more requisition lists are created by one or more buyers, that both published and unpublished buyer constraints are created (including setting of constraint limits), that a sourcing event directed to the fulfillment of the requisition list is opened by the buyers and that suppliers submit bids that are received by the system 13. This process is described in great detail starting in paragraph [0095] of Appendix I. In an alternative embodiment, the results of a sourcing event need not be received by system 13, but can be received by another system and entered into system 13. Regardless, the bids received or entered into system 13 can be maintained in the store 26 described with reference to FIG. 2. Referring to FIG. 4A, in step 1 of the process, the optimization engine 23 employs the received bidding information to optimize the mathematical model 24A which results in an initial value “z*” for the model 24A which can be considered to be an initial optimal award schedule scenario. At this point in step 2, a buyer can elect to create one or more alternative award scenarios, in which case the process proceeds to step 3. If the buyer does not elect to create alternative award scenarios, the process comes to an end or the buyer can elect to manually create alternative scenarios. In step 3, the buyer or the system 13 defines a significance value “f” to be some fractional or absolute amount of the initial value “z*” of the mathematical model 24A. As was described earlier, the amount assigned to the significance value can be subjective, and the assigned magnitude of the significance value can change from buyer to buyer depending upon the objective information included in a bidding event. Proceeding to step 4, the buyer can select one or more unpublished constraints 26B, maintained in the store 26, for alteration.

Referring now to FIG. 4B, in step 5 the buyer can set a flexibility value “f” for each constraint selected in step 4 of the process and in step 6 the sourcing event management system 13 calculates a unpublished constraint variable “sᵢ” for each constraint selected in step 4. In step 7, the mathematical model 24B is evaluated, subject to all of the unpublished constraint variables calculated in step 6, and in step 8 the system 13 identifies whether or not modifications can be made to the unpublished constraints which will have a significant effect on the initial value of the mathematical model “z*”. If not, the process proceeds to step 9 where the buyer can elect to create more scenarios or not. If the buyer elects to not create any additional scenarios, then the process ends, otherwise, the process returns to step 2 of FIG. 4A. If in step 8 the system 13 identifies that modifications can be made to the unpublished constraints which will have a significant effect upon the initial value of the mathematical model “z*”, then the process proceeds to step 10 in FIG. 4C.

Referring now to FIG. 4C, in step 10 the system 13 can make a recommendation that the buyer modifies the definition of one or more of the unpublished constraints selected in step in step 4 of the process and in step 11, the buyer makes some or all of the modifications to the constraints recommended by the system 13. Alternatively, the system 13 can automatically make the modifications and optimize the modified scenario without buyer intervention. In step 12, the buyer commands the system 13 to optimize the mathematical model 24A, subject to the modified constraints and in step 13 the system 13 returns an alternative award scenario that has been improved subject to the modifications to the constraints made by the buyer in step 11. In step 14, the buyer can elect to either accept the alternative award schedule returned by the system 13 in step 13, in which case the process comes to an end, or the buyer can elect to create more alternative scenarios, in which case the process can return to step 2 of FIG. 4A.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. A method for automatically generating at least one scenario used to optimize a bid: award schedule, comprising:
a buyer specifying that a mathematical model includes at least one flexibility element;
a sourcing event management system using the results of a sourcing event to evaluate the mathematical model which results in an initial bid award value;
the buyer specifying a value for the mathematical model flexibility element;
the sourcing event management system using the specified flexibility element value to calculate a special mathematical model variable; and
the sourcing event management system evaluating the mathematical model subject to the special mathematical model variable to identify at least one scenario that will improve the initial bid award value.

2. The method of claim 1 further comprising the sourcing event management system displaying the at least one scenario that will improve the initial bid award value.

3. The method of claim 2 further comprising entering the at least one scenario into the sourcing event management system and the sourcing event management system evaluating a mathematical model subject to the entered at least one scenario to improve a bid award schedule.

4. The method of claim 1 wherein the resulting initial bid award value is determined by:
the buyer creating a bidding event scenario and causing the sourcing event management system to initiate the event;
the sourcing event management system receiving bids; and
the sourcing event management system evaluating the mathematical model subject to the accepted bids which results in an initial bid award value.

5. The method of claim 1 wherein the mathematical model is comprised of an objective function and one or more constraints.

6. The method of claim 5 wherein the objective function is comprised of at least one of a price term, a non-price term and a discounts term.

7. The method of claim 5 wherein the constraints are comprised of at least one buyer constraint and at least one supplier constraint.

8. The method of claim 7 wherein the at least one buyer and at least one supplier constraint are one of a published and an unpublished constraint.

9. The method of claim 1 wherein the flexibility element is a constraint flexibility variable.

10. The method of claim 1 wherein the constraint flexibility variable value is one of a relative value and an absolute value.

11. A method for automatically generating at least one alternative sourcing event scenario used to optimize a bid award schedule, comprising:
a buyer defining a plurality of constraints to an objective function, at least one of which is a flexible constraint, and storing the constraints in a sourcing event management system;
the buyer creating a first sourcing event and causing the sourcing event management system to initiate the event;
the sourcing event management system receiving and storing bids from one or more suppliers;
the sourcing event management system evaluating the objective function, subject to one or more of the plurality of the buyer defined constraints and the suppliers bids, resulting in an initial bid award value;
the buyer specifying a value for a constraint flexibility variable;
the sourcing event management system using the constraint flexibility variable value to calculate a special constraint variable for the at least one flexible constraint: and
the sourcing event management system evaluating the objective function subject to the special constraint variable to identify a scenario that will improve the initial bid award value.

12. The method of claim 11 further comprising the sourcing event management system displaying an indication of the identified scenario that will improve the initial bid award value.

13. The method of claim 12 further comprising entering the identified scenario into the sourcing event management system and the sourcing event management system evaluating the objective function subject to the entered identified scenario to improve a bid award schedule.

14. The method of claim 11 wherein the objective function is comprised of one of a price term, a non-price term and a discounts term.

15. The method of claim 14 wherein the identified scenario is comprised of one or more modifications to the plurality of buyer defined constraints.

16. The method of claim 11 wherein the plurality of buyer defined constraints are comprised of at least one published constraint and at least one unpublished constraint.

17. The method of claim 16 wherein the value of the constraint flexibility variable is one of a relative value and an absolute value.

18. The method of claim 11 wherein the special constraint variable is applied to one of a published and an unpublished constraint.

19. A computational device, comprising:
a memory, the memory including:
a sourcing event management system comprised of:
an optimization engine;
an objective function;
one or more constraints;
a bidding event scenario; and
bids received from one or more suppliers, the sourcing event management system evaluating the objective function, subject to the one or more constraints and received bids, which results in an initial bid award value, specifying a limiting value and a flexibility value for each of the one or more constraints; using the specified limiting value and the flexibility value to calculate a special constraint variable for each of the one or more constraints; and minimizing the objective function subject to each of the calculated constraint variable to identify modifications to the one or more constraints that will improve the initial bid award value.

20. The computational device of claim 19 further comprising the sourcing event management system displaying an indication of the identified modifications to the one or more constraints.

21. The computational device of claim 20 further comprising the sourcing event management system evaluating the objective function, subject to constraint modifications entered into the sourcing event management system, to improve a bid award schedule.

22. The apparatus of claim 19 wherein the objective function is comprised of one of a price term, a non-price term and a discounts term.

23. The apparatus of claim 19 wherein the constraints are comprised of at least one buyer constraint and at least one supplier constraint.

24. The apparatus of claim 19 wherein the at least one buyer constraint is one of a published constraint and an unpublished constraint.

25. The apparatus of claim 19 wherein the special constraint variable is applied to one of a published and an unpublished constraint.
